(19) United States
(12) Patent Application Publication
(10) Pub. No.: US 2026/0274628 A1
(43) Pub. Date: Sep. 17, 2026

(54) FORKLIFT VEHICLE

(71) Applicant: GM GLOBAL TECHNOLOGY OPERATIONS LLC, Detroit, MI (US)

(72) Inventor: Wade W. Bryant, Grosse Pointe Farms, MI (US)

(21) Appl. No.: 19/076,104

(22) Filed: Mar. 11, 2025

(51) Int. Cl. B66F 9/08

(52) U.S. Cl. CPC B66F 9/085

(57) ABSTRACT

A forklift vehicle including: a chassis; wheels mounted to the chassis; a body mounted to the chassis defining a first enclosure and a second enclosure; a first forklift assembly including first forks, the first forklift assembly mounted to the chassis within the first enclosure and configured to move the first forks out of and into the first enclosure, raise the first forks, and lower the first forks; and a second forklift assembly including second forks, the second forklift assembly mounted to the chassis within the second enclosure and configured to move the second forks out of and into the second enclosure, raise the second forks, and lower the second forks.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to forklift vehicles.

A forklift is a vehicle configured to lift and transport items from one area to another. Forklifts often include a pair of metal prongs (typically referred to as forks), which can be raised and lowered to lift and move the items. Forklifts are used in various industries including, but not limited to, warehousing, manufacturing, construction, etc. Forklifts may be powered by electric motors, internal combustion engines, or any suitable hybrid system, for example. A hydraulic system may be included to control a lifting mechanism configured to raise and lower the prongs.

### SUMMARY

The present disclosure provides for, in various features, a forklift vehicle including: a chassis; wheels mounted to the chassis; a body mounted to the chassis defining a first enclosure and a second enclosure; a first forklift assembly including first forks, the first forklift assembly mounted to the chassis within the first enclosure and configured to move the first forks out of and into the first enclosure, raise the first forks, and lower the first forks; and a second forklift assembly including second forks, the second forklift assembly mounted to the chassis within the second enclosure and configured to move the second forks out of and into the second enclosure, raise the second forks, and lower the second forks.

In further features, the first enclosure is opposite to the second enclosure, and the first forklift assembly is opposite to the second forklift assembly; and in a retracted configuration of each of the first forklift assembly and the second forklift assembly, a first mast assembly of the first forklift assembly and a second mast assembly of the second forklift assembly are adjacent to each other and arranged back-to-back.

In further features, the first forklift assembly and the second forklift assembly are laterally offset from each other in a direction parallel to an axle of the forklift vehicle.

In further features, the first enclosure is configured to accommodate a first pallet in cooperation with the first forks, and the second enclosure is configured to accommodate a second pallet in cooperation with the second forks.

In further features, the first forklift assembly is further configured to tilt the first forks up and down, and the second forklift assembly is further configured to tilt the second forks up and down.

In further features, the first forklift assembly is further configured to lower the first forks to a first park position below the body and against a surface beneath the body that the wheels are seated on, and the second forklift assembly is further configured to lower the second forks to a second park position below the body and against the surface beneath the body that the wheels are seated on, to restrict movement of the forklift vehicle and park the forklift vehicle; and the forklift vehicle further includes carrier locks configured to lock the first forks in the first park position and lock the second forks in the second park position.

In further features, a first pallet engagement device is mounted to the body at the first enclosure and a second pallet engagement device mounted to the body at the second enclosure. The first pallet engagement device is movable towards and away from the first forks to cooperate with a first pallet seated on the first forks and restrict movement of the first pallet. The second pallet engagement device is movable towards and away from the second forks to cooperate with a second pallet seated on the second forks and restrict movement of the second pallet.

In further features, at least one of the first pallet engagement device and the second pallet engagement device includes a plurality of spring-loaded pins configured to cooperate with the first pallet or the second pallet.

In further features, at least one of the first pallet engagement device and the second pallet engagement device includes an inflatable member configured to cooperate with the first pallet or the second pallet when inflated.

In further features, each one of the first forklift assembly and the second forklift assembly includes: a first mast; a second mast in cooperation with the first mast, the second mast slidably movable upward and downward along the first mast; a support assembly configured to move both the first mast and the second mast out of and into the body; and a pully mounted to the first mast and in cooperation with the second mast, the pully movable to raise and lower the second mast relative to the first mast, cooperation between the pully and a pully collar of the second mast restricts rotation of the pully.

The present disclosure also provides for, in various features, a forklift vehicle including: a chassis; wheels mounted to the chassis; a body mounted to the chassis defining a first enclosure and a second enclosure; a first forklift assembly; and a second forklift assembly. The first forklift assembly is mounted to the chassis within the first enclosure and includes: first forks; a first mast assembly to which the first forks are mounted, the first mast assembly configured to raise and lower the first forks; and a first support assembly in cooperation with the first mast assembly and configured to shift the first mast assembly and the first forks out of and into the first enclosure. The second forklift assembly is mounted to the chassis within the second enclosure and includes: second forks; a second mast assembly to which the second forks are mounted, the second mast assembly configured to raise and lower the second forks; and a second support assembly in cooperation with the second mast assembly and configured to shift the second mast assembly and the second forks out of and into the second enclosure.

In further features, the first support assembly is configured to move the first mast assembly and the first forks between a first retracted position within the first enclosure and a first extended position outside of the first enclosure; the second support assembly is configured to move the second mast assembly and the second forks between a second retracted position within the second enclosure and a second extended position outside of the second enclosure; and in the first retracted position and the second retracted position, the first mast assembly and the second mast assembly are nested together.

In further features, the first forklift assembly and the second forklift assembly are laterally offset from each other in a direction parallel to an axle of the forklift vehicle.

In further features, the first support assembly includes a pair of first support tracks in cooperation with the first mast assembly, a plurality of first extender arms in cooperation with the first mast assembly, and a plurality of first hydraulic actuators configured to rotate the plurality of first extender arms to slide the first mast assembly along the pair of first support tracks and move the first mast assembly between the first retracted position and the first extended position; and the second support assembly includes a pair of second support tracks in cooperation with the second mast assembly, a plurality of second extender arms in cooperation with the second mast assembly, and a plurality of second hydraulic actuators configured to rotate the plurality of second extender arms to slide the second mast assembly along the pair of second support tracks and move the second mast assembly between the second retracted position and the second extended position.

In further features, the first support assembly includes a pair of first support tracks in cooperation with the first mast assembly, a first pair of telescoping members in cooperation with the first mast assembly, and a first motor configured to extend and retract the first pair of telescoping members to slide the first mast assembly along the pair of first support tracks and move the first mast assembly between the first retracted position and the first extended position; and the second support assembly includes a pair of second support tracks in cooperation with the second mast assembly, a second pair of telescoping members in cooperation with the second mast assembly, and a second motor configured to extend and retract the second pair of telescoping members to slide the second mast assembly along the pair of second support tracks and move the second mast assembly between the second retracted position and the second extended position.

In further features, the forklift vehicle includes a first pallet engagement device mounted to the body at the first enclosure and a second pallet engagement device mounted to the body at the second enclosure. The first pallet engagement device is movable towards and away from the first forks to cooperate with a first pallet seated on the first forks and restrict movement of the first pallet during travel of the forklift vehicle. The second pallet engagement device is movable towards and away from the first forks to cooperate with a second pallet seated on the second forks and restrict movement of the second pallet during travel of the forklift vehicle.

The present disclosure still further provides for, in various features, a chassis; a body mounted to the chassis defining a first enclosure and a second enclosure opposite to the first enclosure; a first forklift assembly mounted to the chassis within the first enclosure; and a second forklift assembly mounted to the chassis within the second enclosure. The first forklift assembly includes: first forks; a first mast assembly to which the first forks are mounted, the first mast assembly configured to raise and lower the first forks; and a first support assembly in cooperation with the first mast assembly and configured to slide the first mast assembly and the first forks between a first retracted position inside of the first enclosure and a first extended position outside of the first enclosure. The second forklift assembly includes: second forks; a second mast assembly to which the second forks are mounted, the second mast assembly configured to raise and lower the second forks; and a second support assembly in cooperation with the second mast assembly and configured to slide the second mast assembly and the second forks between a second retracted position inside of the second enclosure and a second extended position outside of the second enclosure. In the first retracted position and the second retracted position, the first mast assembly and the second mast assembly are nested together.

In further features, the first forklift assembly and the second forklift assembly are laterally offset from each other in a direction parallel to an axle of the forklift vehicle.

In further features, the forklift vehicle includes: a first pallet engagement device mounted to the body at the first enclosure and a second pallet engagement device mounted to the body at the second enclosure. The first pallet engagement device is movable towards and away from the first forks to cooperate with a first pallet seated on the first forks and restrict movement of the first pallet. The second pallet engagement device is movable towards and away from the second forks to cooperate with a second pallet seated on the second forks and restrict movement of the second pallet.

In further features, the first forklift assembly is further configured to lower the first forks to a first park position below the body and against a surface beneath the body that wheels of the forklift vehicle are seated on, and the second forklift assembly is further configured to lower the second forks to a second park position below the body and against the surface beneath the body that the wheels are seated on, to restrict movement of the forklift vehicle and park the forklift vehicle. The forklift vehicle further includes carrier locks configured to lock the first forks in the first park position and lock the second forks in the second park position.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a pair of forklift vehicles according to the present disclosure;

FIG. 2 is a perspective view of one of the forklift vehicles of FIG. 1;

FIG. 3 is a top view of the forklift vehicle of FIG. 2;

FIG. 4 is a perspective view of the forklift vehicle of FIG. 2 with a body of the forklift vehicle removed, both a first mast assembly and a second mast assembly are in retracted positions;

FIG. 5 is a perspective view of the forklift vehicle of FIG. 2 with the first mast assembly in an extended position and the second mast assembly in the retracted position;

FIG. 6 is an exploded view of the first mast assembly, and a carriage of the forklift vehicle with a pair of forks;

FIG. 7 is a perspective view of a lower portion of a first enclosure of the forklift vehicle, within the first enclosure are the pair of forks as well as two pallet engagement devices configured to cooperate with a pallet on the pair of forks, the pair of forks are in contact with a ground surface in a park position to act as a kickstand for the forklift vehicle and restrict movement of the forklift vehicle;

FIG. 8 is a perspective view of a pallet engagement device in accordance with the present disclosure;

FIG. 9 is a perspective view of the lower portion of the first enclosure of the forklift vehicle with the pallet engagement device in cooperation with a pallet to retain the pallet on the forks and within the first enclosure;

FIG. 10 is a perspective view of spring-loaded pins of the pallet engagement device;

FIG. 11 is a perspective view of another pallet engagement device in accordance with the present disclosure in cooperation with the pallet; and

FIG. 12 is a perspective view of the forklift vehicle including an alternative support assembly in an extended position to support the mast assembly outside of the enclosure of the body.

In the drawings, reference numbers may be reused to identify similar and/or identical elements.

### DETAILED DESCRIPTION

The present disclosure is generally directed to a forklift vehicle including at least two forklift assemblies. The forklift assemblies are mounted to a common chassis. The forklift vehicle may be configured as an autonomous vehicle, semi-autonomous vehicle, or a manually operated vehicle. The forklift vehicle may be coupled to any suitable number of additional forklift vehicles with any suitable coupling assembly. The forklift vehicles may be identical, or substantially similar, to each other.

Each one of the forklift assemblies includes a mast assembly configured to raise and lower forks, or any other suitable support members. The forks are configured to support items to be transported from one location to another, such as on a pallet. Each one of the forklift assemblies is individually movable between a retracted position and an extended position. In the retracted position, the forklift assemblies are within a body of the forklift vehicle. Specifically, in the retracted position the first forklift assembly is within a first enclosure defined by the body and the second forklift assembly is within a second enclosure defined by the body. Cargo carried by the forklift assemblies is protected by the body when the forklift assemblies are within the enclosures defined by the body. When retracted, the mast assemblies are arranged in a back-to-back relationship with portions of the forklift assemblies nested together to reduce an overall footprint of the forklift assemblies and the forklift vehicle, which facilitates rotation of the forklift vehicle within a single vehicle lane.

The forklift vehicle further includes one or more pallet engagement devices within the enclosures of the body. The pallet engagement devices are configured to cooperate with the pallets to hold the pallets stationary. The pallet engagement devices thus secure the pallets and the cargo thereon as the forklift vehicle transports the cargo between from one location to another.

Each one of the forklift assemblies is individually movable to the extended position by a separate support assembly. To move one of the forklift assemblies to the extended position, the support assembly is configured to slide at least a portion of the mast assembly out from within the respective enclosure and out from within the body of the vehicle. The mast assembly may then raise the associated forks above the body to unload cargo at an elevated position, such as at a position higher than the body of the forklift vehicle.

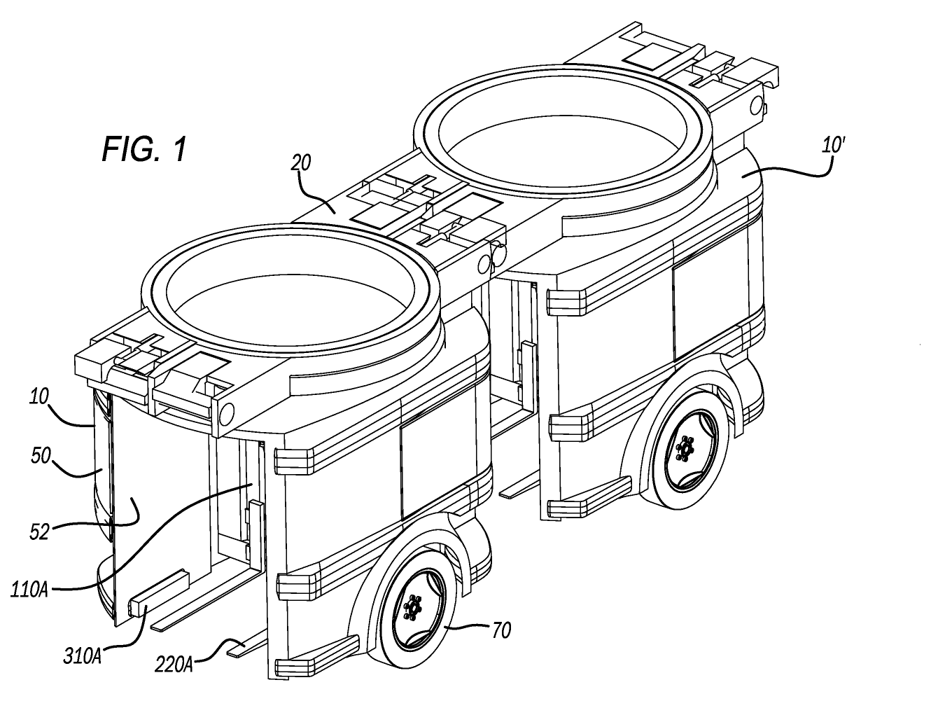

FIG. 1 illustrates a forklift vehicle 10 in accordance with the present disclosure. The forklift vehicle 10 is coupled to an additional forklift vehicle 10ʹ, which is substantially similar to, or the same as, the forklift vehicle 10. The forklift vehicle 10 and the additional forklift vehicle 10ʹ are coupled together in any suitable manner, such as with a coupling assembly 20. The coupling assembly 20 may be configured to couple two forklift vehicles as illustrated, or any suitable number of additional forklift vehicles to provide a train of forklift vehicles. The coupling assembly 20 is configured to allow each one of the forklift vehicles, such as the forklift vehicle 10 and the additional forklift vehicle 10ʹ, to rotate independently of one another about the coupling assembly 20. For example, the forklift vehicle 10 is configured to rotate 180° (or in some applications 360°) as the coupling assembly 20 and the forklift vehicle 10ʹ remain stationary.

The forklift vehicle 10 is described in detail herein, and illustrated in the remaining figures. Because of the forklift vehicle 10 is the same as, or substantially similar to, the additional forklift vehicle 10ʹ, the following description of the forklift vehicle 10 also applies to the additional forklift vehicle 10ʹ. The following description of the forklift vehicle 10 also applies to any additional forklift vehicles that may be coupled together as a train of forklift vehicles.

The forklift vehicle 10 is configured for use in any suitable application to transport various items of cargo from one location to another. For example, the forklift vehicle 10 may be used in any suitable manufacturing operation, such as vehicle manufacturing or any suitable non-vehicular manufacturing. The forklift vehicle 10 may also be configured for use in conjunction with any suitable construction work, environmental work, transportation operation, logistics operation, etc. The forklift vehicle 10 may further be configured for use in any suitable warehouse or shipping operation. As explained herein, the forklift vehicle 10 is configured to position cargo on forks and within a housing of the forklift vehicle 10 to protect the cargo as the forklift vehicle 10 travels from one location to another. The forklift vehicle 10, the additional forklift vehicle 10ʹ, and any other forklift vehicles coupled together may be controlled autonomously, semi-autonomously, and/or manually.

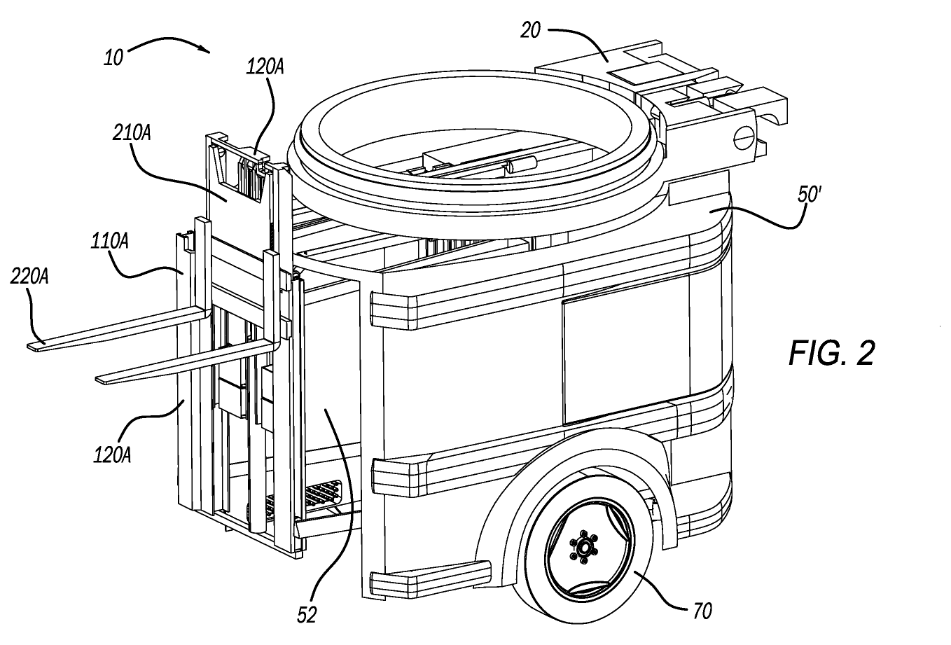

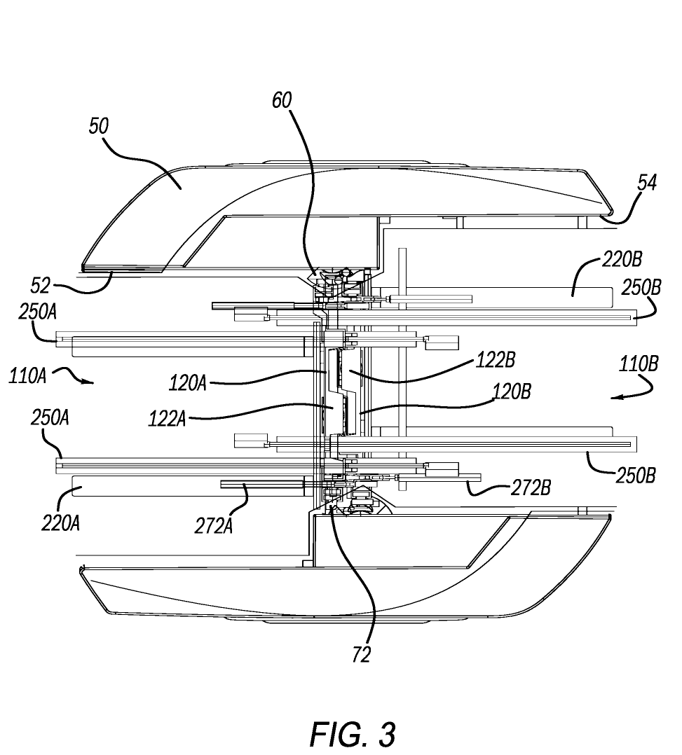

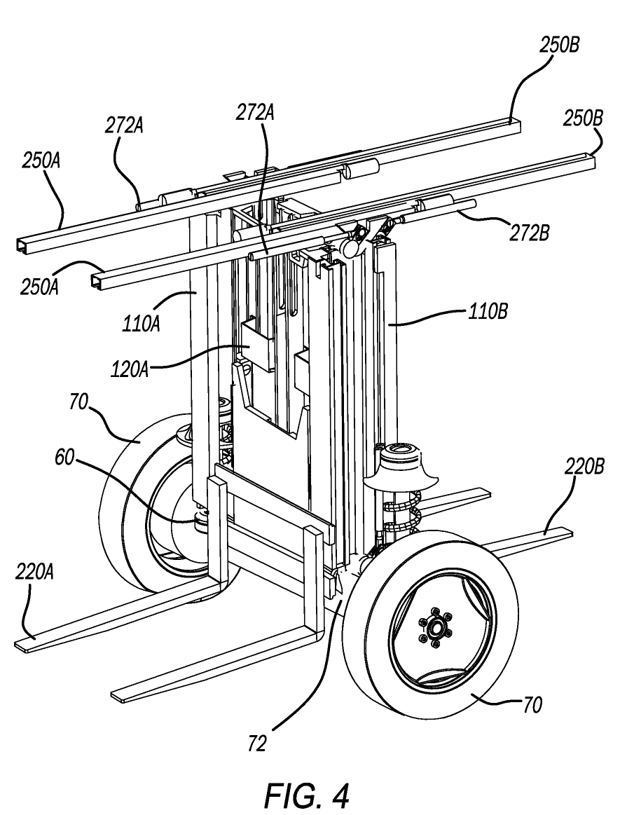

With continued reference to FIG. 1, and additional references to FIGS. 2-4, the forklift vehicle 10 includes a body 50, which is mounted to a chassis 60 (FIGS. 3 and 4). The body 50 defines a first enclosure 52 and a second enclosure 54. With particular reference to FIG. 3, the first enclosure 52 and the second enclosure 54 are opposite to one another so as to be at opposite sides of the body 50 in a back-to-back relationship. The forklift vehicle 10 further includes at least two of the wheels 70. At least one axle 72 supports the wheels 70. Any suitable number of additional wheels 70 and axles 72 may be included.

The forklift vehicle 10 further includes a first forklift assembly 110A and a second forklift assembly 110B. The first forklift assembly 110A is mounted to the chassis 60 and arranged within the first enclosure 52. The second forklift assembly 110B mounted to the chassis 60 and is within the second enclosure 54. With particular reference to FIG. 3, the first forklift assembly 110A and the second forklift assembly 110B are mounted in a back-to-back relationship with some portions thereof nested together, as explained herein. The first forklift assembly 110A and the second forklift assembly 110B are laterally offset from each other with respect to a direction parallel to the axle 72 of the forklift vehicle 10. Arranging the first forklift assembly 110A and the second forklift assembly 110B in a back-to-back, nesting relationship reduces the footprint of the first forklift assembly 110A and second forklift assembly 110B, and reduces the overall footprint of the forklift vehicle 10, which facilitates rotation of the forklift vehicle 10 within a single vehicle lane.

The first forklift assembly 110A and the second forklift assembly 110B are the same as, or substantially similar to, each other. The description herein of the first forklift assembly 110A is thus sufficient to describe the second forklift assembly 110B. Features of the second forklift assembly 110B are identified in the drawings using the same reference numerals used to identify features of the first forklift assembly 110A, but include the suffix “B” instead of “A.”

The first forklift assembly 110A generally includes a first mast assembly 120A with a carriage 210A mounted thereto. The first forks 220A are coupled to the carriage 210A. The first forks 220A may also be configured as, and/or referred to as, tines, prongs, etc. Any suitable number of the first forks 220A may be included, such as two forks as illustrated, a single fork, or more than two forks. Furthermore, the first forks 220A may be sized and shaped in any suitable manner to support a pallet, or any other suitable cargo. The second forklift assembly 110B likewise includes a second mast assembly 120B including the second forks 220B.

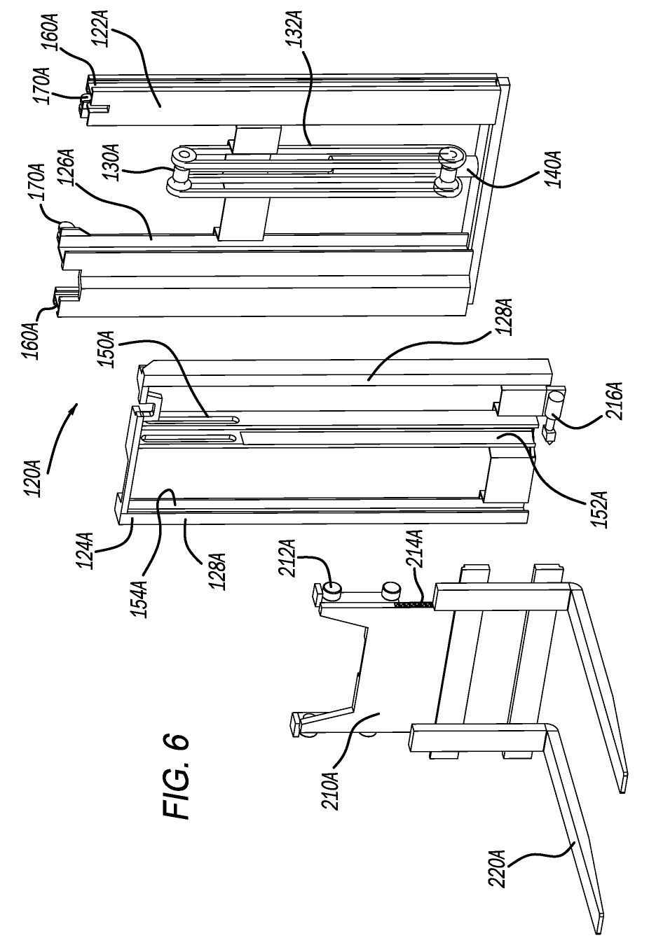

With particular reference to FIG. 6, the first mast assembly 120A includes an outer mast 122A and an inner mast 124A. The inner mast 124A is in cooperation with the outer mast 122A to allow the inner mast 124A to slide vertically relative to the outer mast 122A, as explained herein. The outer mast 122A generally includes inner tracks 126A, which are configured to cooperate with posts 128A of the inner mast 124A.

Mounted to the outer mast 122A is a pulley 130A, which is moved up and down by a lift cylinder 140A. In cooperation with the pulley 130A is a roller chain 132A. The pulley 130A is seated within a pulley collar 150A of the inner mast 124A. The pulley collar 150A is configured to resist rotation of the pulley 130A, such as when the pulley 130A moves up and down. The lift cylinder 140A is seated within a slot 152A of the inner mast 124A.

The carriage 210A is mounted to the inner mast 124A by way of flanges 212A of the carriage 210A. The flanges 212A are seated within tracks 154A defined by the posts 128A. Actuation of the lift cylinder 140A and the pulley 130A moves the inner mast 124A up and down relative to the outer mast 122A, and moves the carriage 210A vertically up and down along the inner mast 124A to raise and lower the first forks 220A.

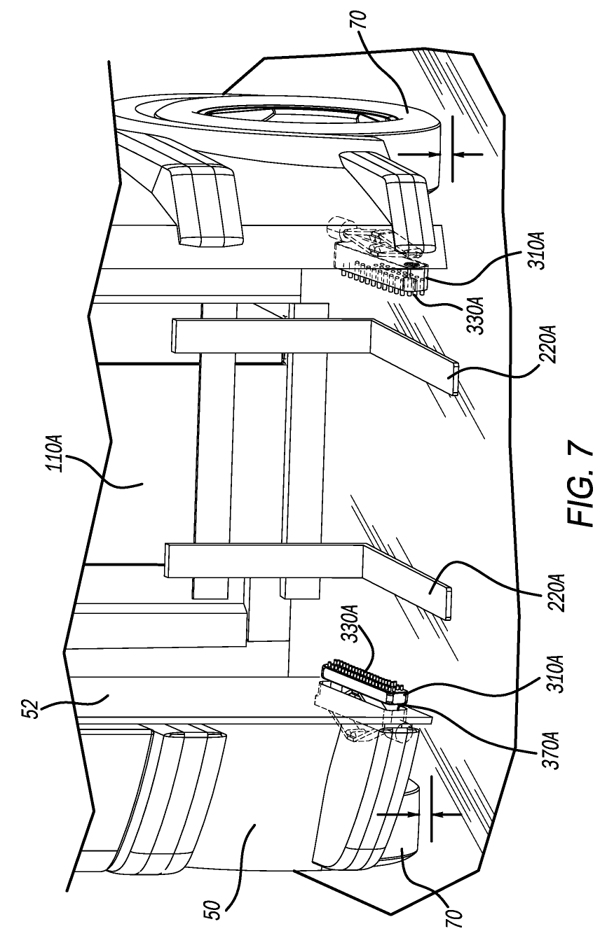

The carriage 210A further includes locking tabs 214A, which are configured to cooperate with a locking pin 216A of the inner mast 124A. The locking pin 216A is at a bottom of, or near a bottom of, the inner mast 124A. The first forklift assembly 110A is configured to lower the first forks 220A below the body 50 and against, or into, a ground surface that the wheels 70 are seated on (see FIG. 7, for example). In this park position, the first forks 220A provide a support or “kickstand” for the forklift vehicle 10, which helps to support the forklift vehicle 10 upright particularly when decoupled from the additional forklift vehicle 10ʹ. In the park position, the locking pin 216A is configured to cooperate with the locking tabs 214A of the carriage 210A to lock the first forks 220A in the park position. The second forklift assembly 110B is configured to move the second forks 220B to a similar park position and lock the second forks 220B in the lock position.

The outer mast 122A further includes outer tracks 160A, which are opposite to the inner tracks 126A. Mounting points 170A are included at or near a top of the outer mast 122A. The mounting points 178 may be configured in any suitable manner for mounting the first mast assembly 120A slidably to support tracks within the body 50, as described herein.

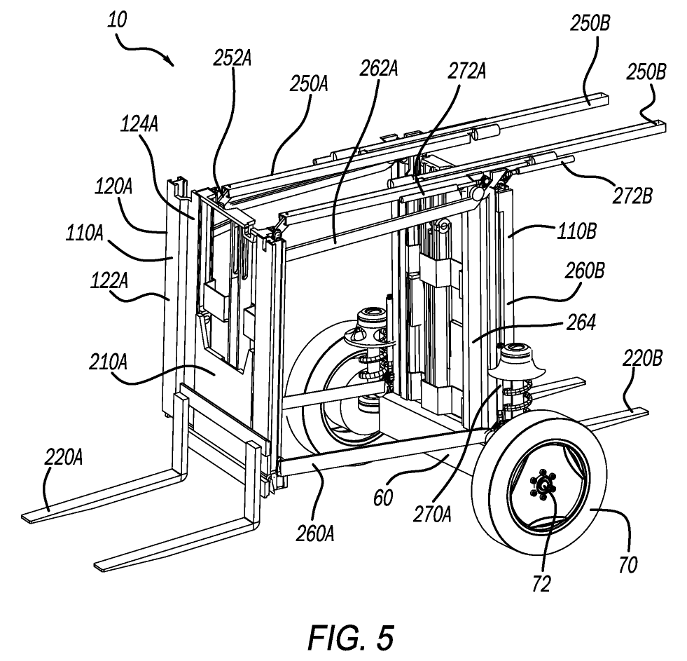

With particular reference to FIGS. 3, 4, and 5, the forklift vehicle 10 further includes first support tracks 250A and second support tracks 250B within the body 50. The first support tracks 250A are at an upper area of the first enclosure 52, and the second support tracks 250B are at an upper area of the second enclosure 54. The first mast assembly 120A is slidably mounted to the first support tracks 250A in any suitable manner, such as by way of support brackets 252A (FIG. 5). The support brackets 252A are in cooperation with both the mounting points 170A and the first support tracks 250A. The second mast assembly 120B is likewise slidably mounted to the second support tracks 250B.

The first support tracks 250A and the support brackets 252A are part of a first support assembly for the first mast assembly 120A. The first support assembly further includes lower extender arms 260A and upper extender arms to 262A, as illustrated in FIG. 5, for example. The lower extender arms 260A are pivotably mounted to the chassis 60 (or adjacent to the chassis 60) and in cooperation with the outer tracks 160A of the outer mast 122A. One or more lower actuators 270A are configured to rotate the lower extender arms 260A. The lower actuators 270A may be hydraulic actuators, for example, or any other suitable actuation device.

With continued reference to FIG. 5, for example, the upper extender arms 262A are pivotably mounted to a support member 264, which is mounted to the chassis 60. Distal ends of the upper extender arms 262A are seated within the inner tracks 126A of the outer mast 122A. One or more upper actuators 272A are included and configured to rotate the upper extender arms 262A. The upper actuators 272A may be hydraulic actuators, or any other suitable actuation device configured to rotate the upper extender arms 262A. An upper actuator 272B is included to rotate upper extender arms of the second forklift assembly 110B, along with additional support assembly members corresponding to those of the first forklift assembly 110A.

FIG. 4 illustrates the first forklift assembly 110A and the second forklift assembly 110B both in a retracted position. With respect to the first forklift assembly 110A, in the retracted position the first mast assembly 120A is retracted into the first enclosure 52 and the first forks 220A are within the first enclosure 52. Likewise, in the retracted position of the second forklift assembly 110B, the second mast assembly 120B and the second forks 220B are seated within the second enclosure 54. Thus, in the retracted positions any items carried by the first forks 220A and the second forks 220B are protected by the body 50, which facilitates transport of the items from one location to another.

With particular reference to FIG. 3, in the retracted positions of the first forklift assembly 110A and the second forklift assembly 110B, the first mast assembly 120A and the second mast assembly 120B are arranged back-to-back within the body 50. Portions of the first mast assembly 120A and the second mast assembly 120B are nested together to minimize packaging space, thereby allowing the forklift vehicle 10 to accommodate two standard-sized pallets, and rotate within the width of a vehicle lane. In particular, the outer mast 122A nests within the outer mast 122B of the second forklift assembly 110B. To permit such nesting, the first forklift assembly 110A and the second forklift assembly 110B are offset from each other, such as in a direction parallel to the axle 72. In particular, the pulley 130A and the lift cylinder 140A are offset with respect to a corresponding pulley and lift cylinder of the outer mast 122B to accommodate the nested relationship.

FIGS. 2 and 5 illustrate the first forklift assembly 110A in an extended position, such as after having been shifted out from within the first enclosure 52 from the retracted position of FIGS. 1, 3, and 4, for example. To shift the first forklift assembly 110A to the extended position, the lower actuators 270A and the upper actuators 272A are activated to rotate outward the lower extender arms 260A and the upper extender arms 262A, respectively. As the lower extender arms 260A and the upper extender arms 262A rotate outward, the lower extender arms 260 slide along the outer tracks 160A and the upper extender arms 262A slide along the inner tracks 126A of the outer mast 122A to push the first mast assembly 120A outward along the first support tracks 250A out from within the first enclosure 52. In this extended, outward position, the first mast assembly 120A is free to raise the carriage 210A and the first forks 220A upward, thereby allowing a load supported by the first forks 228 to be unloaded, such as on an elevated surface. The second forklift assembly 110B is configured to be shifted outward to an extended position in a similar manner.

To facilitate loading and unloading, the lower extender arms 260A and the upper extender arms 262A may be individually rotated in any suitable manner to tilt the first mast assembly 120A in or out in order to tilt the first forks 220A up or down. For example, from the extended position of FIG. 5, the lower extender arms 260A may be rotated more than the upper extender arms 262A to rotate the first forks 220A down. Conversely, the upper extender arms 262A may be rotated further than the lower extender arms 260A to tilt the first forks 220A up. The second forks 220B may be tilted up or down by actuation of the second forklift assembly 110B in a similar manner.

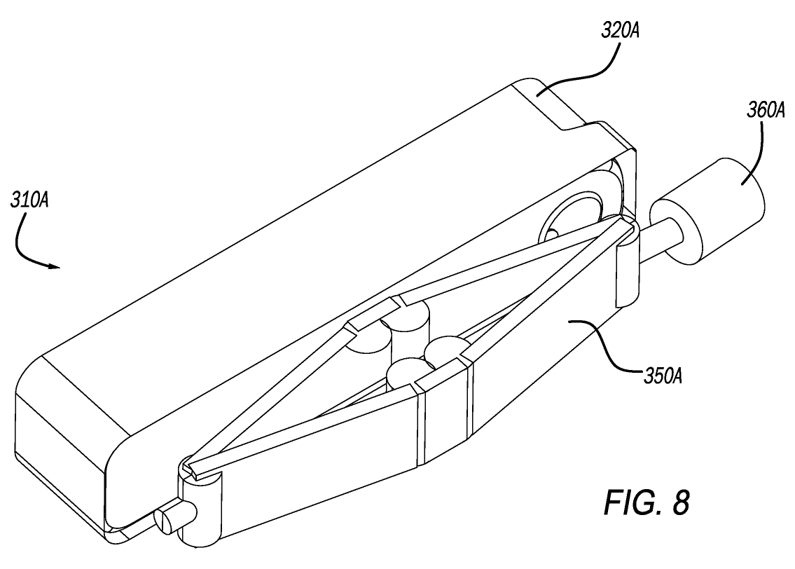

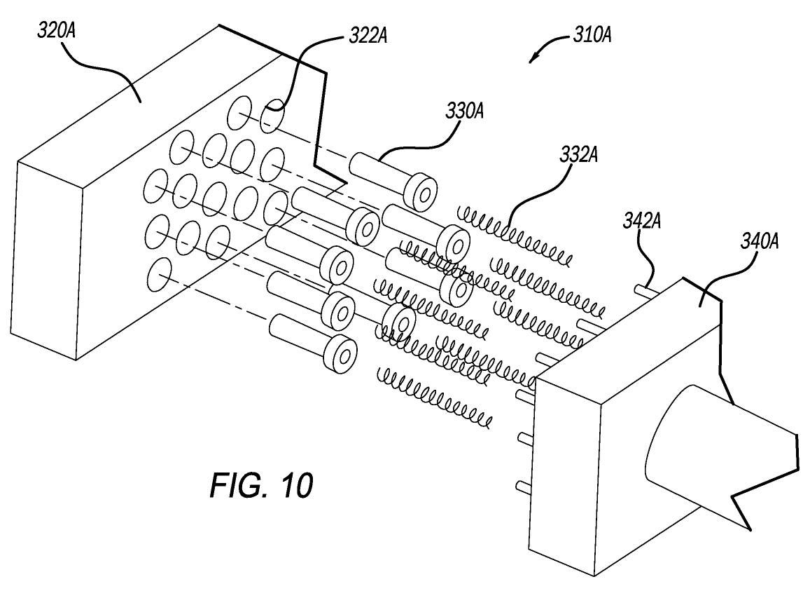

With additional reference to FIG. 7, the present disclosure further includes pallet engagement devices, which are configured to cooperate with any pallet seated on the first forks 220A or the second forks 220B to restrict movement of the pallets during travel of the forklift vehicle 10. FIGS. 7-10 illustrate a pallet engagement device 310A in accordance with the present disclosure. The pallet engagement device 310A includes, with particular reference to FIG. 10, a cover 320A defining openings 322A. Seated within the openings 322A are pins 330A, which are spring loaded with springs 332A arranged within the pins 330A. The springs 332A are seated on spring guides 342A. The spring guides 342A extend from a carrier 340A. The pins 330A extend through the openings 322A and extend out beyond the cover 320A, as illustrated in FIGS. 7 and 8, for example.

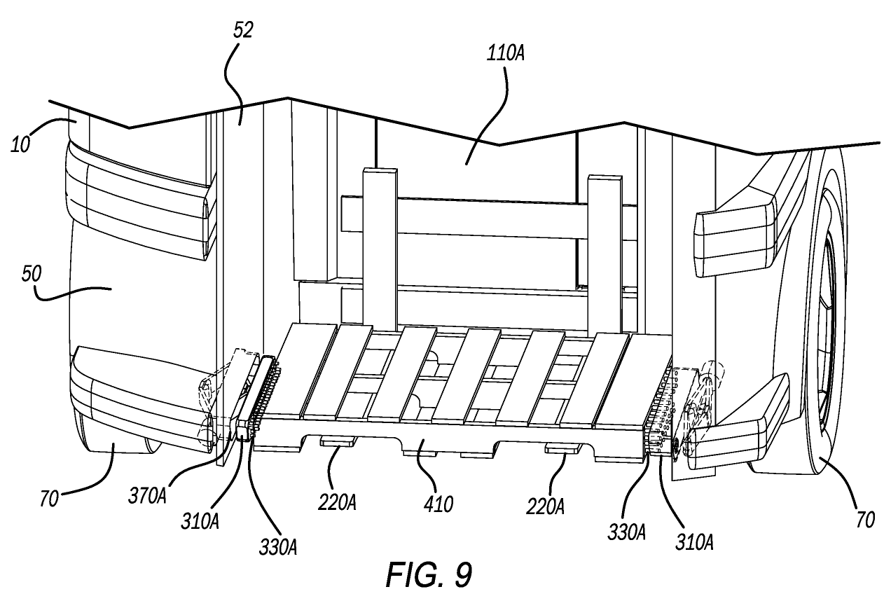

With particular reference to FIG. 8, the pallet engagement device 310A further includes an actuator 350A. The actuator 350A may be any suitable actuation device, such as a scissor extender as illustrated. A motor 360A is in cooperation with the actuator 350A to move the actuator 350A between extended and retracted positions. With reference to FIG. 7, the pallet engagement device 310A is mounted within a receptacle 370A defined within the first enclosure 52. When the actuator 350A is retracted, the cover 320A and pins 330A are retracted within, or at least partially within, the receptacle 370A. FIG. 9 illustrates the actuator 350A in an extended position to extend the cover 320A and the pins 330A outward into cooperation with a pallet 410 seated on the first forks 220A. Cooperation between the pins 330A and the pallet 410 locks the pallet 410 in place to restrict movement of the pallet 410 during travel of the forklift vehicle 10.

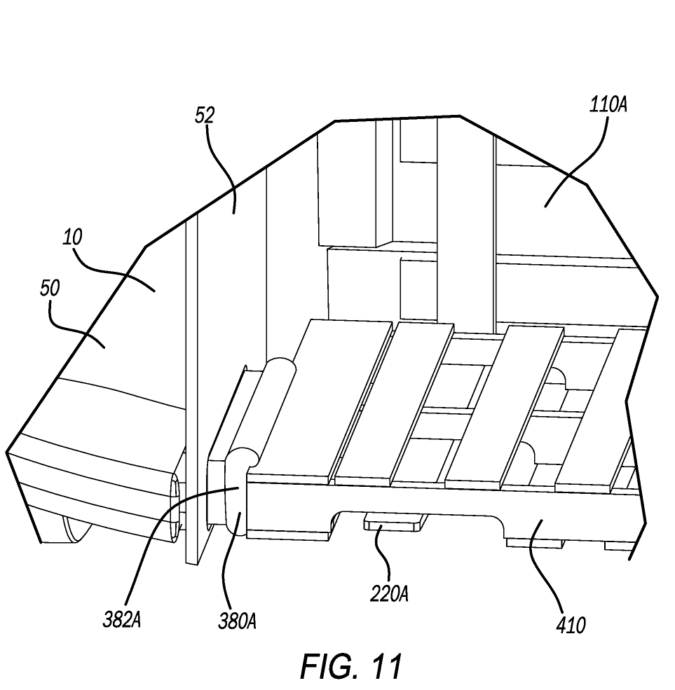

FIG. 11 illustrates another pallet engagement device 380A in accordance with the present disclosure. The pallet engagement device 380A includes an inflatable bag 382A, which is configured to cooperate with the pallet 410 when inflated to restrict movement of the pallet 410 as the forklift vehicle 10 travels between locations. The second enclosure 54 includes a second pallet engagement device that is the same as, or substantially similar to, the pallet engagement device 310A or the pallet engagement device 380A.

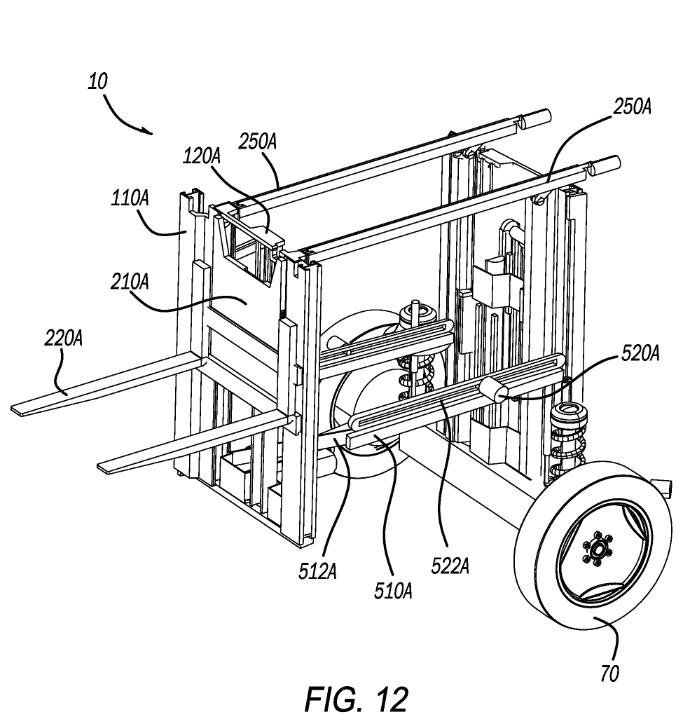

FIG. 12 illustrates an additional configuration of the support assembly for the first mast assembly 120A (which may also be included with the second mast assembly 120B). In the configuration of FIG. 12, the lower extender arms 260A and the upper extender arms 262A are replaced with a telescoping assembly 510A. The telescoping assembly 510A includes arms 512A and a motor 520A that is configured to actuate the arms 512A inward and outward by way of a belt drive 522A. Specifically, the arms 512A are movable from the retracted position to the extended position of FIG. 12 to slide the first mast assembly 120A along the first support tracks 250A. A similar telescoping assembly may be included to actuate the second mast assembly 120B.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A forklift vehicle comprising:
a chassis;
wheels mounted to the chassis;
a body mounted to the chassis defining a first enclosure and a second enclosure;
a first forklift assembly including first forks, the first forklift assembly mounted to the chassis within the first enclosure and configured to move the first forks out of and into the first enclosure, raise the first forks, and lower the first forks; and
a second forklift assembly including second forks, the second forklift assembly mounted to the chassis within the second enclosure and configured to move the second forks out of and into the second enclosure, raise the second forks, and lower the second forks.

2. The forklift vehicle of claim 1, wherein:
the first enclosure is opposite to the second enclosure, and the first forklift assembly is opposite to the second forklift assembly; and
in a retracted configuration of each of the first forklift assembly and the second forklift assembly, a first mast assembly of the first forklift assembly and a second mast assembly of the second forklift assembly are adjacent to each other and arranged back-to-back.

3. The forklift vehicle of claim 2, wherein the first forklift assembly and the second forklift assembly are laterally offset from each other in a direction parallel to an axle of the forklift vehicle.

4. The forklift vehicle of claim 1, wherein the first enclosure is configured to accommodate a first pallet in cooperation with the first forks, and the second enclosure is configured to accommodate a second pallet in cooperation with the second forks.

5. The forklift vehicle of claim 1, wherein the first forklift assembly is further configured to tilt the first forks up and down, and the second forklift assembly is further configured to tilt the second forks up and down.

6. The forklift vehicle of claim 1, wherein the first forklift assembly is further configured to lower the first forks to a first park position below the body and against a surface beneath the body that the wheels are seated on, and the second forklift assembly is further configured to lower the second forks to a second park position below the body and against the surface beneath the body that the wheels are seated on, to restrict movement of the forklift vehicle and park the forklift vehicle; and
wherein the forklift vehicle further includes carrier locks configured to lock the first forks in the first park position and lock the second forks in the second park position.

7. The forklift vehicle of claim 1, further comprising a first pallet engagement device mounted to the body at the first enclosure and a second pallet engagement device mounted to the body at the second enclosure,
wherein the first pallet engagement device is movable towards and away from the first forks to cooperate with a first pallet seated on the first forks and restrict movement of the first pallet, and
wherein the second pallet engagement device is movable towards and away from the second forks to cooperate with a second pallet seated on the second forks and restrict movement of the second pallet.

8. The forklift vehicle of claim 7, wherein at least one of the first pallet engagement device and the second pallet engagement device includes a plurality of spring-loaded pins configured to cooperate with the first pallet or the second pallet.

9. The forklift vehicle of claim 7, wherein at least one of the first pallet engagement device and the second pallet engagement device includes an inflatable member configured to cooperate with the first pallet or the second pallet when inflated.

10. The forklift vehicle of claim 1, wherein each one of the first forklift assembly and the second forklift assembly includes:
a first mast;
a second mast in cooperation with the first mast, the second mast slidably movable upward and downward along the first mast;
a support assembly configured to move both the first mast and the second mast out of and into the body; and
a pully mounted to the first mast and in cooperation with the second mast, the pully movable to raise and lower the second mast relative to the first mast, cooperation between the pully and a pully collar of the second mast restricts rotation of the pully.

11. A forklift vehicle comprising:
a chassis;
wheels mounted to the chassis;
a body mounted to the chassis defining a first enclosure and a second enclosure;
a first forklift assembly mounted to the chassis within the first enclosure including:
first forks;
a first mast assembly to which the first forks are mounted, the first mast assembly configured to raise and lower the first forks; and
a first support assembly in cooperation with the first mast assembly and configured to shift the first mast assembly and the first forks out of and into the first enclosure; and
a second forklift assembly mounted to the chassis within the second enclosure including:
second forks;
a second mast assembly to which the second forks are mounted, the second mast assembly configured to raise and lower the second forks; and
a second support assembly in cooperation with the second mast assembly and configured to shift the second mast assembly and the second forks out of and into the second enclosure.

12. The forklift vehicle of claim 11, wherein:
the first support assembly is configured to move the first mast assembly and the first forks between a first retracted position within the first enclosure and a first extended position outside of the first enclosure;
the second support assembly is configured to move the second mast assembly and the second forks between a second retracted position within the second enclosure and a second extended position outside of the second enclosure; and
in the first retracted position and the second retracted position, the first mast assembly and the second mast assembly are nested together.

13. The forklift vehicle of claim 12, wherein the first forklift assembly and the second forklift assembly are laterally offset from each other in a direction parallel to an axle of the forklift vehicle.

14. The forklift vehicle of claim 12, wherein:
the first support assembly includes a pair of first support tracks in cooperation with the first mast assembly, a plurality of first extender arms in cooperation with the first mast assembly, and a plurality of first hydraulic actuators configured to rotate the plurality of first extender arms to slide the first mast assembly along the pair of first support tracks and move the first mast assembly between the first retracted position and the first extended position; and
the second support assembly includes a pair of second support tracks in cooperation with the second mast assembly, a plurality of second extender arms in cooperation with the second mast assembly, and a plurality of second hydraulic actuators configured to rotate the plurality of second extender arms to slide the second mast assembly along the pair of second support tracks and move the second mast assembly between the second retracted position and the second extended position.

15. The forklift vehicle of claim 12, wherein:
the first support assembly includes a pair of first support tracks in cooperation with the first mast assembly, a first pair of telescoping members in cooperation with the first mast assembly, and a first motor configured to extend and retract the first pair of telescoping members to slide the first mast assembly along the pair of first support tracks and move the first mast assembly between the first retracted position and the first extended position; and
the second support assembly includes a pair of second support tracks in cooperation with the second mast assembly, a second pair of telescoping members in cooperation with the second mast assembly, and a second motor configured to extend and retract the second pair of telescoping members to slide the second mast assembly along the pair of second support tracks and move the second mast assembly between the second retracted position and the second extended position.

16. The forklift vehicle of claim 11, further comprising a first pallet engagement device mounted to the body at the first enclosure and a second pallet engagement device mounted to the body at the second enclosure,
wherein the first pallet engagement device is movable towards and away from the first forks to cooperate with a first pallet seated on the first forks and restrict movement of the first pallet during travel of the forklift vehicle, and
wherein the second pallet engagement device is movable towards and away from the first forks to cooperate with a second pallet seated on the second forks and restrict movement of the second pallet during travel of the forklift vehicle.

17. A forklift vehicle comprising:
a chassis;
a body mounted to the chassis defining a first enclosure and a second enclosure opposite to the first enclosure;
a first forklift assembly mounted to the chassis within the first enclosure including:
first forks;
a first mast assembly to which the first forks are mounted, the first mast assembly configured to raise and lower the first forks; and
a first support assembly in cooperation with the first mast assembly and configured to slide the first mast assembly and the first forks between a first retracted position inside of the first enclosure and a first extended position outside of the first enclosure; and
a second forklift assembly mounted to the chassis within the second enclosure including:
second forks;
a second mast assembly to which the second forks are mounted, the second mast assembly configured to raise and lower the second forks; and
a second support assembly in cooperation with the second mast assembly and configured to slide the second mast assembly and the second forks between a second retracted position inside of the second enclosure and a second extended position outside of the second enclosure,
wherein in the first retracted position and the second retracted position, the first mast assembly and the second mast assembly are nested together.

18. The forklift vehicle of claim 17, wherein the first forklift assembly and the second forklift assembly are laterally offset from each other in a direction parallel to an axle of the forklift vehicle.

19. The forklift vehicle of claim 17, further comprising a first pallet engagement device mounted to the body at the first enclosure and a second pallet engagement device mounted to the body at the second enclosure,
wherein the first pallet engagement device is movable towards and away from the first forks to cooperate with a first pallet seated on the first forks and restrict movement of the first pallet, and
wherein the second pallet engagement device is movable towards and away from the second forks to cooperate with a second pallet seated on the second forks and restrict movement of the second pallet.

20. The forklift vehicle of claim 17, wherein the first forklift assembly is further configured to lower the first forks to a first park position below the body and against a surface beneath the body that wheels of the forklift vehicle are seated on, and the second forklift assembly is further configured to lower the second forks to a second park position below the body and against the surface beneath the body that the wheels are seated on, to restrict movement of the forklift vehicle and park the forklift vehicle; and
wherein the forklift vehicle further includes carrier locks configured to lock the first forks in the first park position and lock the second forks in the second park position.
